(19) United States
(12) Patent Application Publication
(10) Pub. No.: US 2005/0127031 A1
(43) Pub. Date: Jun. 16, 2005

(54) Clear label for use on a dark container, and method for manufacturing the same

(76) Inventors: Paul F. Cote, Hollis, NH (US); Daniel G. Leeds, Manchester, NH (US)

Correspondence Address: BURNS & LEVINSON LLP, 1030 15TH STREET NW, SUITE 300, WASHINGTON, DC, 20005-1501, US

(21) Appl. No.: 10/989,865

(22) Filed: Nov. 16, 2004

Related U.S. Application Data
(60) Provisional application No. 60/520,694, filed on Nov. 17, 2003.

(51) Int. Cl. B44C 1/22

(52) U.S. Cl. 216/41

(57) ABSTRACT

The present invention relates to a method for achieving extremely bright, reflective and opaque graphics on clear labels for use on dark bottles, containers, and other light absorbent backgrounds with improvements to cost, production rates and graphic design capabilities. The method includes steps of vacuum metalizing an aluminum metalized film to specified thickness; printing multiple etching resistant inks on the aluminum surface of the aluminum metalized film; and demetalizing non-inked areas of said film.

### CROSS REFERENCE TO RELATED APPLICATIONS

This application relates to and claims priority benefit under 35 U.S.C. § 119(e) to U.S. Provisional Patent Application Ser. No. 60/520,694, entitled “Clear Label for Use on A Dark Container, and Method for Manufacturing the Same”, filed Nov. 17, 2003, which is hereby incorporated by reference in its entirety.

### FIELD OF THE INVENTION

The present invention is directed to an article and method of achieving extremely bright, reflective, and opaque graphics on clear labels and packaging for use on dark bottles and containers with improvements to cost, production rates and graphic design capabilities.

### BACKGROUND OF THE INVENTION

The use of clear labels on food and beverage containers has grown tremendously in popularity. Traditional printing methods do not easily produce graphics with adequate brightness and opacity, especially when the labels are adhered to or wrapped around containers with low brightness and or color such as beer, soda and tea in, clear, colored and dark plastic and glass containers. The reason that these traditional printing methods such as lithography, gravure and flexography have failed to be utilized is the inherent limitations these processes have in their ability to print an adequate ink film thickness to give the inks enough opacity to block the absorption of light by the dark containers behind the film labels. Labels or films produced with these traditional printing methods typically result in severe to moderate darkening of colors, even of white ink.

The success of this packaging decoration style has been largely achieved by taking advantage of the ability of a rotary screen process to deposit thick ink films on clear labels. The rotary or flat screen process is able to deposit thick ink films with less resolution degradation than the other processes would achieve if they attempted similar ink film thicknesses. The resolution achieved by the screen process is a compromise that is reluctantly accepted in order to get the colors to remain bright and opaque.

Unfortunately, the thick ink film rotary screen printing process has several disadvantages over the more traditional printing methods. These drawbacks include large consumption of expensive inks. The significant majority of all these labels utilize ultraviolet cured inks, which are significantly more expensive per kilogram than traditional solvent or water-based materials. The fact that the rotary screen process inks are thick makes them more difficult to print other colors over with ease. The think ink films also may require reduced production rates in order to properly cure or evaporate the volatiles. As previously mentioned, the screen process is not capable of the resolutions that may be achieved by printing thin ink films by other printing methods. This limit to resolution causes severe limitations to design flexibility and potential features within the graphic design.

The desire of label designers to incorporate metallic graphic elements has traditionally been achieved with the use of metallic transfer foils, metallic pigmented inks and metalized flake ink. These methods are traditionally expensive to utilize. Designs are compromised to reduce this increased cost burden. In order to achieve the required opacity over a dark background, these metals or metallic pigments may also need to be applied at extreme thicknesses. Additionally, many colors need to be printed over a sub-layer of white ink to achieve adequate light reflection. Stacking of multiple layers of thick inks makes the cohesive strength of the ink to ink bonding extremely important to achieve adequate durability when the bottles and containers are subjected to the hazards of filling, pasteurization and case packing lines.

The technique of demetalization is generally well known in the packaging and security printing industries. The process has been performed by different variations for several decades. Demetalization has been utilized to produce windows in metalized packaging film as well as its traditional and widespread acceptance as a method of forming metallic characters and patterns on security threads, laminates and holograms used on banknotes and other security documents.

The demetalization process is used on the disclosed thin ink film labels to make the background areas of the “clear” labels transparent to allow the dark package color to be seen through the film. The intent of the clear areas is to create the illusion that there is not a label on the package, but that the ink may be printed directly onto the container.

The demetalization process generally involves the steps of printing an etching resistant resin in a pattern which protects the areas where the aluminum is to be preserved. The plastic web is then subjected to a caustic solution by means of a roller or spray. The preferred caustic material is sodium hydroxide but others may be used. The etchant is varies in its concentration by dilution with water. The dilution may be in a range from five percent to twenty-five percent as described by Beckett in U.S. Pat. No. 4,398,994. To accelerate the etching process, the etchant may be heated from approximately 50 degrees Celsius to 90 degrees Celsius.

The final step used in the demetalization process is to rinse the web to remove any remaining etchant as well as the reaction products from the chemical etching process. The web is then dried with warm air.

The typical application of demetalization in the packaging industry has been to provide decorative metallic patterns and windows in food bags to allow the consumer to view the contents of the package. Demetalization has also been used to make patterned aluminum reigns in the bottom of microwave popcorn bags.

Demetalization has also been widely used to give more security to aluminum-based holograms. Further, demetalization techniques have been applied to create transparency on holograms by patterning a screen tint that allows light to partially pass through the partially metalized hologram film.

The demetalizing process, as described above, is disclosed by U.S. Pat. No. 4,398,994 by Beckett, U.S. Pat. No. 4,242,378 by Arai, and U.S. Pat. No. 4,126,511 by Ford.

Another variation of demetalization that is not used in the current invention is by U.S. Pat. No. 4,869,778 by Cote.

In contrast, the present invention improves the demetalization process to apply it for the purpose of providing opacity and brightness to thin ink films on light absorbent backgrounds. The tremendous advantages created by the invention has significant financial and efficiency impacts on the production process and cost of raw materials. The invention further greatly expands the readily achievable design possibilities for the graphics on these labels competing for maximum shelf impact on the consumer.

The use of thin ink film by other printing processes such as gravure and flexography allow printing significantly higher resolution graphic designs. This allows for fine lines, halftone prints, process printing, vignettes, etc. Additionally, metallic colors are easily achievable at low cost. The ability to produce intricate metallic vignettes is not producible by any other process and is readily achievable by the described process.

It is an object of the invention to use more traditional ink film thicknesses, even on labels applied to black body reflectors, results in significantly and substantially improved process and product conditions and results. These include the ability to manufacture these “clear” labels with other traditional printing process which have major advantages over the screen printing process.

It is an object of the invention to dramatically reduce ink cost due to the ability to use a significantly less volume of ink.

It is an object of the invention to further dramatically reduce ink cost due to the ability to use more traditional air dry inks rather than the ultraviolet cured ink traditionally used for rotary screen printing.

It is yet another object of the invention to achieve dramatically higher potential production speeds due to the reduction of cure and/or evaporation requirements of the thinner ink films.

Still another object of the present invention is to generate the ability to print at significantly higher graphic resolutions. This will open the design limitations dramatically for the label designers and customers.

It is also an object of the present invention to generate the ability to print color photo type graphics on the bottles without the need for a white ink behind the cyan, yellow, and magenta inks. A negative image of the black printer may be printed in white ink using the absorption qualities of the bottle to darken the shadow areas of graphics.

It is an object of the invention to generate the ability to print transparent pigmented inks to create metallic colors that are even better than hot foil transfer.

It is an object of the invention to generate the ability to print these foil type colors in extremely high resolution. This has not been easily or economically done by previous methods.

It is yet another object of the invention to generate the ability to achieve these metal foil colors without the use of expensive inks.

### SUMMARY OF THE INVENTION

The disclosed invention addresses all of the previously mentioned shortfalls in achieving and using a label that has clear areas and must achieve bright and/or metallic colors on a dark package or bottle with graphics at higher resolutions.

The invention has the potential for theoretically even brighter graphic appearance than is currently experienced with the traditional rotary screen printing method.

The method comprises the steps of vacuum metalizing an aluminum metalized film to specified thickness; printing multiple etching resistant inks on the aluminum surface of the aluminum metalized film; and demetalizing non-inked areas of said film.

### BRIEF DESCRIPTION OF THE DRAWINGS

FIG. 1 shows the inventive method of producing clear labels by printing thick opaque inks onto clear film.

FIG. 2 shows the process steps from raw material to finished clear label in accordance with the present invention.

FIG. 3 shows a pressure sensitive clear label, created with the inventive method, on a silicone coated liner carrier material.

FIG. 4 shows a clear label adhered to a dark surface in accordance with the present invention.

FIG. 5 shows a label adhered to a bottle in accordance with the present invention.

### DESCRIPTION OF THE PREFERRED EMBODIMENT

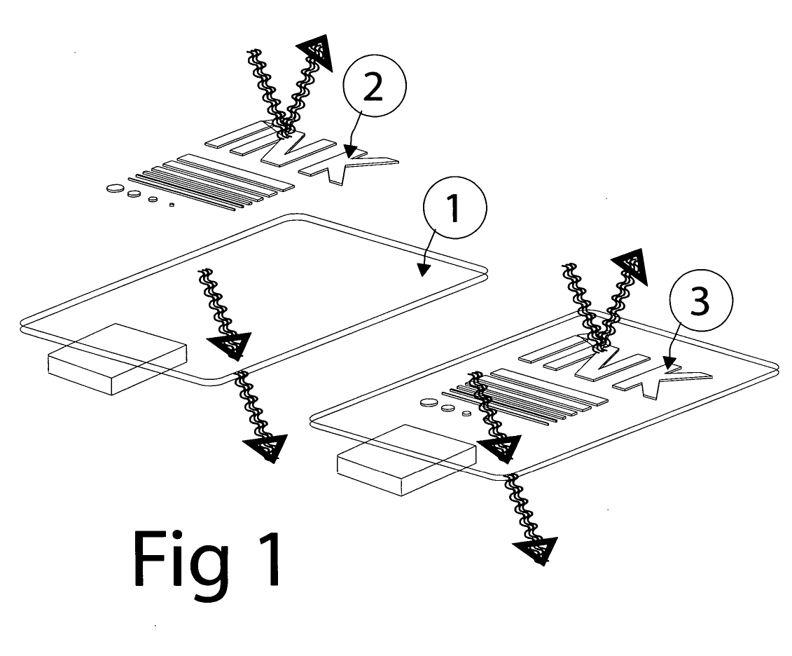

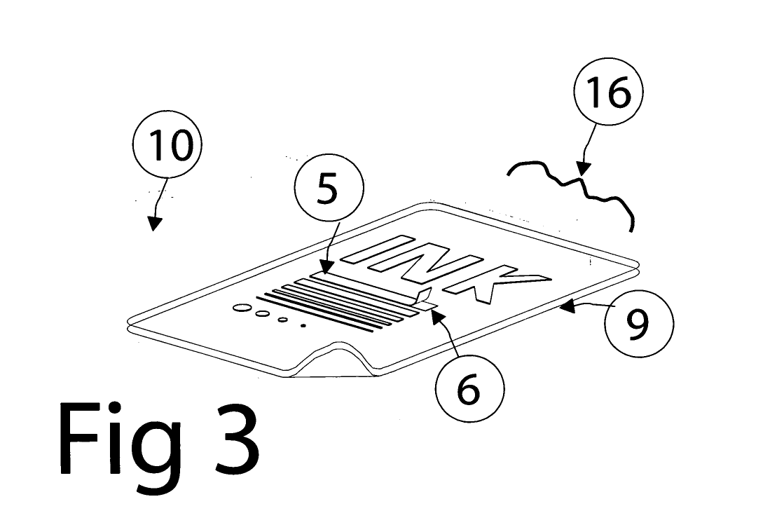

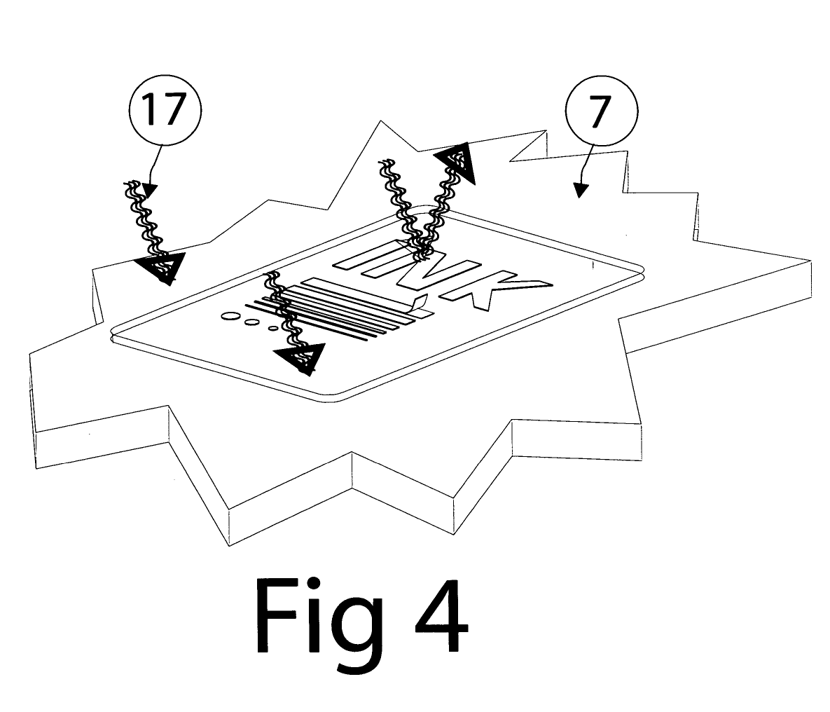

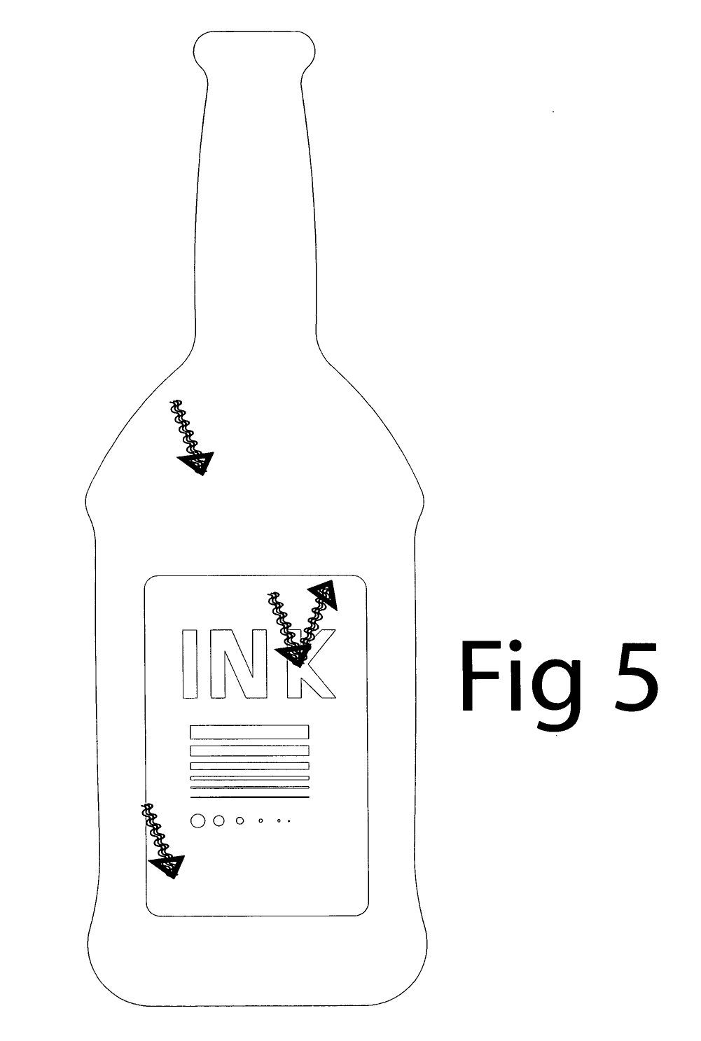

The method of producing clear labels by printing thick opaque ink onto clear film of the present invention is shown in FIGS. 1, 2, 3, 4, and 5. The numbered items below refer to numbered items in the figures. The same number in different figures refers to the same item or features in reference to the figure number. The invention capitalizes on the optical phenomenon of printing traditional inks on aluminum metalized film 6. This combination does not present the difficulties that printing on clear film 1 that is subsequently imposed over a dark background or object 7. The invention uses the process of demetalization of the areas that are desired to remain clear or see through 4. This demetalization happens on all of the areas where inks or clear coatings have not been printed 6. The ink serves a secondary purpose of acting like an etching resist for the demetalization etching process. The intricately patterned layer is automatically in perfect registration to the ink due to the fact that the protected aluminum is exactly positioned below the protective ink. The ink resins are selected to provide both good, economical printing results and to be compatible with and able to survive the demetalization process at high production speeds.

The metal layer behind essentially all of the ink provides greater than ninety-nine percent opacity and reflectivity even with relatively thin ink films 12. The ink is no longer required to overcome the absorption 17 by the dark surface behind the clear film 13. The aluminum provides the majority of the light reflection properties 14 for the eye to perceive. The color of the background has no effect on the brightness and perceived opacity of the graphic design.

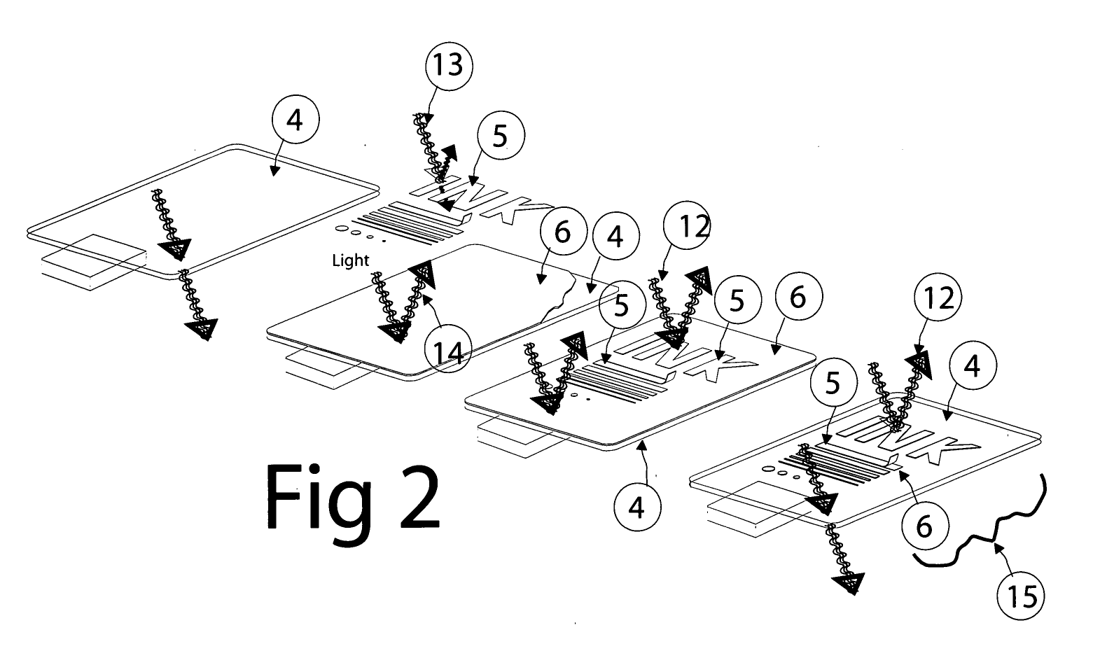

As an example, as shown in FIG. 2, when a thin ink film of light blue ink 5 is printed on the aluminum surface of the metal, the metal 6 reflects over ninety-eight percent of the light that strikes it 14. The light blue 5 ink only has to achieve enough light scattering to be perceived as light blue as opposed to highly reflective aluminum 6. The ink film 5 that is required to achieve this illusion is a fraction of the ink and pigment 2 required to create the bright light blue effect over a dark background 7 with clear film substrate 1.

The preferred embodiment of the inventive method of demetalization improvement consists of vacuum metallizing 15u homopolymer biaxial oriented polypropylene film (BOPP) film 4 with aluminum 6 to a thickness of approximately 100-300 angstroms. Multiple thin film, etching resistant inks 5 are then printed onto the aluminum surface 6 of the BOPP film 4. Other films such as co-extruded BOPP or PET or polyethylene may be used as well. The etching resistant inks 5 may have white or other light scattering pigment added to make the inks more opaque in appearance, which reduces any metallic appearance of the ink over the metal. These inks may also be clear or transparent by containg no pigment or color to create regions which are aluminum in appearance.

The film is then demetalized 4 either in the same printing operation or as a separate printing machine operation in the areas which are not covered with inks 4 or clear coatings. The use of caustic or other etching chemical quickly removes the exposed aluminum surface. A rinsing solution of water is then applied which removes any residual etchant as well as any reaction products on the film and ink surface.

In another embodiment of the inventive method, additional colors are printed in registration to prior colors. These inks may be printed over metallic areas or printed on the clear background areas. This is a design advantage where the effect of printing on a dark background may create effects more desirable than printing over the highly reflective aluminum. For example, one may print a color over both the metal areas and clear areas to create the illusion of two distinct colors. The ability to demetalize at any position on the multi color printing press gives the designer the ultimate in design flexability. In an additional embodiment of the inventive method, a laminating adhesive is applied over the surface of the label or film 15. A second BOPP or other film may also be laminated over the surface. This laminated construction provides superior chemical and abrasion resistance during bottle handling and pasteurization process, shipping, and consumer handling.

Further, a protective overcoat resin is optionally applied to protect the structure and provide the desired gloss or texture. This coating is applied over the inks or over the optional second BOPP or other film layer.

In an additional embodiment, the process is performed on metalized pressure sensitive film 16 or could be made into a pressure sensitive construction 16 after the printing steps above. The technique of pressure sensitive label construction is well known in the packaging industry. The film can also be used without the addition of pressure sensitive adhesive and liner for use as a dry stack, cut and stack or roll fed labels or sleeves.

1. A method of producing opaque graphics on clear labels for use on a dark container, the method comprising the steps of:
(a) vacuum metalizing an aluminum metalized film to specified thickness;
(b) printing multiple etching resistant inks on the aluminum surface of the aluminum metalized film; and
(c) demetalizing non-inked areas of said film.

2. The method of claim 1, wherein the aluminum metalized film is selected from the group consisting of homopolymer biaxial oriented polypropylene film, co-extruded biaxial oriented polypropylene film, polyethylene, and other metalized film which is pressure sensitive, non pressure sensitive or subsequently made pressure sensitive.

3. The method of claim 1, in which the aluminum metalized film is covered with aluminum to a thickness of between about 50 to about 500 angstroms of aluminum.

4. The method of claim 1, wherein the etching resisting inks are comprised of a thin ink film thickness of about 0.25 microns to about 4 microns.

5. The method of claim 1, wherein the demetalization of the non-inked areas is performed in the same printing operation or within separate printing operations.

6. The method of claim 1, wherein at least one layer of transparent adhesive is applied on the surface of the aluminum metalized film.

7. The method of claim 1, wherein a protective overcoat resin is applied to the film.

8. The method of claim 1 in which the film is wrapped around the container or partially glued to a container with patterned label glue.

9. The method of claim 1 in which the film is printed to high opacity with line resolutions ranging from about 30 microns to about 300 microns.

10. The method of claim 1, wherein the etching resisting inks contain white or other light scattering pigment.

11. The method of claim 1, wherein the etching resistant inks are colorless, non-pigmented or made using transparent non-light scattering pigments.

12. The method of claim 1, wherein the aluminum metalized surface is demetalized by removing exposed aluminum surface through the use of a caustic material and applying an aqueous rinsing solution to remove residual etchant.

13. The method of claim 1, wherein at least one additional film is applied over the aluminum surface.

14. A method of producing opaque graphics on clear labels for use on a dark container, the method comprising the steps of:
(a) vacuum metalizing an aluminum metalized film to specified thickness;
(b) printing multiple etching resistant inks on the aluminum surface of the aluminum metalized film;
(c) demetalizing non-inked areas of said film; and
(d) enhancing the resulting design by printing additional inks on metalized and demetalized areas.

15. The method of claim 14, wherein at least one layer of transparent adhesive is applied on the surface of the aluminum metalized film.

16. The method of claim 14, in which a protective overcoat resin is applied to the film.

17. The method of claim 14 in which the film is wrapped around the container or partially glued to a container with patterned label glue.

18. The method of claim 14 in which the film is printed to high opacity with line resolutions ranging from about 30 microns to about 300 microns.

19. The method of claim 14, in which at least one protective film is applied to the layered surface.
